(19) United States
(12) Patent Application Publication
(10) Pub. No.: US 2006/0187693 A1
(43) Pub. Date: Aug. 24, 2006

(54) POWER FACTOR CORRECTION APPARATUS

(76) Inventor: Allen Pak Chuen Tang, Hong Kong (HK)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,308

(22) Filed: Jul. 29, 2005

(30) Foreign Application Priority Data
Feb. 23, 2005 (TW) 94105353

(51) Int. Cl. H02M 7/06

(52) U.S. Cl. 363/126

(57) ABSTRACT

A power factor correction (PFC) apparatus is disclosed. The apparatus comprises a DC rectification circuit and a PFC auxiliary circuit. In this apparatus, the PFC auxiliary circuit is coupled between the input and output terminals of the DC rectification circuit. According, not only can the conduction time be increased, but the working current peak is restrained. Thus, the increased size of the choke and inductance of the inductor can be prevented.

### CROSS-REFERENCE TO RELATED APPLICATION

This application claims the priority benefit of Taiwan application serial no. 94105353, filed on Feb. 23, 2005. All disclosure of the Taiwan application is incorporated herein by reference.

### BACKGROUND OF THE INVENTION

1. Field of the Invention

The present invention relates to a power factor correction (PFC) apparatus, and more particularly to a passive PFC apparatus for improving power factors.

2. Description of the Related Art

Power factor reflects the relation between effective power and apparent power consumption of electricity. It is defined as the ratio of the effective power to the apparent power (VA, or voltage multplying current). Basically, a power factor can be used to measure the efficiency of electricity usage. The higher the power factor, the lower the AC source current, and thus the better the electricity usage efficiency. The circuit operational principle of a power factor correction (PFC) circuit in a power supply is to control and adjust phase and the shape of waveform of the input alternating current (AC) as close as possible to the AC voltage waveform, and ideally to make the power factor close to 1. This is very important for electronic devices which require high electricity, or the electricity consumed by the electronic device may exceed the power source current capability.

Generally, PFC circuits include active PFC circuits and passive PFC circuits. An active PFC circuit is composed of a control circuit of an active device and a power switches. In its operational principle, the input current waveform is adjusted to make it as similar to the input voltage waveform as possible. The power factor of the active PFC circuit can be close to 100%.

A passive PFC circuit, however, is composed of passive components such as inductors and capacitors. Due to its low-frequency input current, usually from 50 Hz to 60 Hz, a conventional passive PFC circuit requires a big inductor and its power factor is only from about 75% to about 80%. Because of its complicated control circuit, the active PFC circuit, compared with the passive PFC circuit, has higher manufacturing costs. Based on the cost consideration, the passive PFC circuit still is a preferred choice.

FIG. 1 is a circuit diagram showing a conventional passive PFC choke in an application of a typical bridge rectification circuit. Referring to FIG. 1, the passive PFC circuit comprises an inductor L1, a bridge rectifier B1 and a capacitor C1. The AC voltage source V1 is received and processed by the PFC circuit, and the stable DC voltage is obtained to drive the load represented by a resistor R1.

FIG. 2 is a drawing of signal waveform variations of a conventional passive PFC circuit. In the following, the waveform variations of the FIG. 2 based on the passive PFC circuit in FIG. 1 are discussed. In the bottom of FIG. 2, the AC voltage Vin1 is the AC voltage provided by the AC voltage source V1. After the operation of the passive PFC circuit, the stable DC voltage Vout1 is output to drive the resistor R1. In the top of FIG. 2, the current I1 in dotted line is the current provided by the AC voltage source V1; the current IL1 in solid line is the working current of the inductor L1. In order to describe the variations of the currents I1 and IL1 in detail, the currents IL1 and I1 are shown with reverse current directions in this figure.

The passive PFC circuit of this structure requires a large size and inductance for the inductor L1 to increase the conduction time of the inductor L1 and restrain the peak current of the working current IL1 of the inductor L1, thereby controlling the charging current of the capacitor C1. However, to increase the size and the inductance of the inductor L1, the charging time of the capacitor C1 is delayed. As a result, the capacitor C1 cannot fully charged to the peak voltage of the input AC voltage. This will become worse for the higher power application where a higher value of bulk capacitor C1 is used.

### SUMMARY OF THE INVENTION

Accordingly, the present invention is related to a power factor correction (PFC) apparatus. In the apparatus, a PFC auxiliary circuit is coupled between the input and output terminals of the conventional passive PFC circuit so that a smaller size and inductance of the inductor can be used.

The present invention provides a PFC apparatus. The PFC apparatus is coupled to an alternating current (AC) source, and receives the AC voltage therefrom. The PFC apparatus comprises a DC rectification circuit, a PFC auxiliary circuit and a load. Wherein, the DC rectification circuit receives the AC voltage and outputs a direct current (DC) voltage based on the AC voltage. An input terminal of the PFC auxiliary circuit is electrically coupled to a positive AC input terminal of the AC source, while an output terminal of the PFC auxiliary circuit is electrically coupled to the first terminal of the load to provide part of the working current of the load. A first terminal of the load described above is coupled to a first output terminal of the DC rectification circuit. A second terminal of the load is coupled to a second output terminal of the DC rectification circuit.

According to the PFC apparatus of an embodiment of the present invention, the DC rectification circuit comprises a first inductive reactance device, a bridge rectifier and a second reactance (capacitive) device. Wherein, a first terminal of the first inductive reactance is coupled to the positive AC input terminal of the AC source. A first terminal of the bridge rectifier described above is coupled to a second terminal of the first inductive reactance device. A second terminal of the bridge rectifier is coupled to a negative AC input terminal of the AC source. A first terminal of the second reactance device described above is coupled to a third terminal of the bridge rectifier. A second terminal of the second reactance device is coupled to a fourth terminal of the bridge rectifier.

According to the PFC apparatus of an embodiment of the present invention, the first terminal of the load described above is electrically coupled to the first terminal of the second reactance device, and the second terminal of the load is electrically coupled to the second terminal of the second reactance device.

According to the PFC apparatus of an embodiment of the present invention, the PFC auxiliary circuit is a resonant circuit. The resonant circuit comprises a third reactance (inductive) device and a fourth (capacitive) reactance device. Wherein, a first terminal of the third reactance device described above is coupled to the positive AC input terminal of the AC source. A first terminal of the fourth reactance device described above is coupled to a second terminal of the third reactance device. A second terminal of the fourth reactance device is coupled to the first and the second output terminals of the DC rectification circuit via a second rectification circuit, diode D1 and D2 (306) respectively.

According to the PFC apparatus of an embodiment of the present invention, the PFC auxiliary circuit further comprises a second DC rectification circuit. A first terminal of the second DC rectification circuit is coupled to the second terminal of the fourth reactance, a second terminal of the second DC rectification circuit is coupled to the first output terminal of the DC rectification circuit, and a third terminal of the second DC rectification circuit is coupled to the second output terminal of the DC rectification circuit.

According to the PFC apparatus of an embodiment of the present invention, the second DC rectification circuit further comprises a second diode. A first terminal of the second diode is coupled to the first terminal of the DC rectification circuit and a second terminal of the second diode is coupled to the second output terminal of the DC rectification circuit.

Accordingly, in the PFC apparatus of the present invention, a PFC auxiliary circuit is coupled between the input and output terminals of the DC rectification circuit to increase the conduction time of the input current and restrain the input working current peak. Thus, the problems of increasing the size of the choke and the inductance of the inductor are prevented.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a circuit diagram showing a conventional passive PFC circuit.

FIG. 2 is a drawing showing signal waveform variations of a passive PFC circuit.

FIG. 3 is a schematic circuit drawing of a complete PFC apparatus according to an embodiment of the present invention.

FIGS. 4 and 5 are schematic circuit drawings of PFC apparatuses according to other embodiments of the present invention.

FIG. 6 is a drawing of a waveform of signal variations of a PFC apparatus according to an embodiment of the present invention.

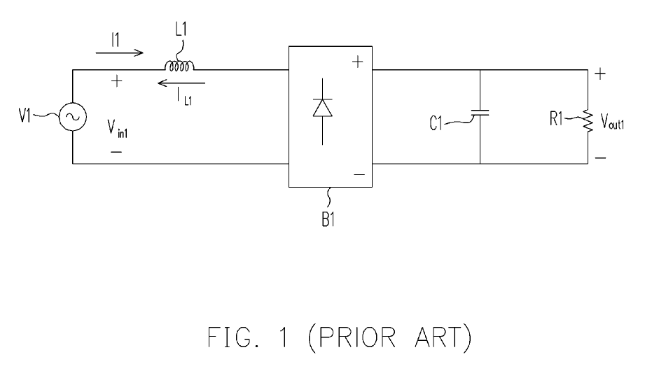

### DESCRIPTION OF SOME EMBODIMENTS

The present invention provides a power factor correction (PFC) apparatus. The present invention is characterized in the PFC auxiliary circuit, which is coupled between the input and output terminals of the traditional DC rectification circuit to increase the conduction time of the input current and restrain the input working current peak, thereby preventing an increased size of the choke and the inductance of the inductor.

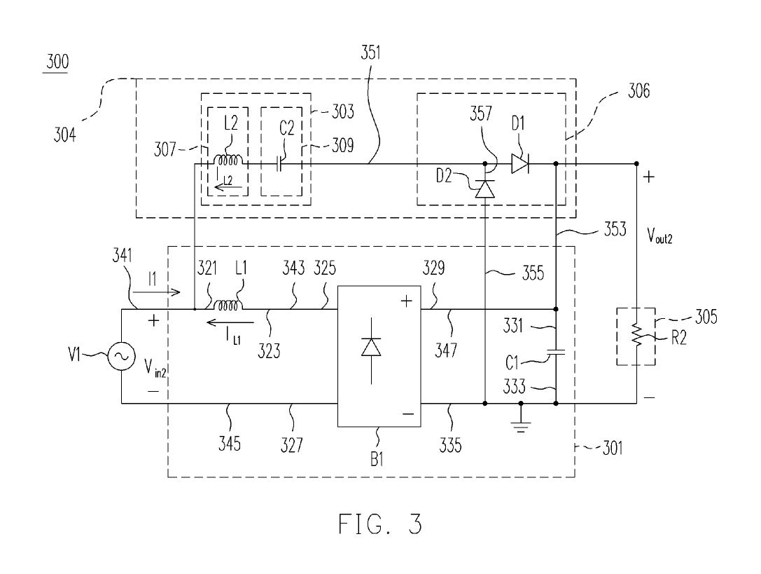

FIG. 3 is a schematic circuit drawing of a complete PFC apparatus according to an embodiment of the present invention. Referring to FIG. 3, the passive PFC circuit 300 of this embodiment comprises a DC rectification circuit 301. This circuit has a structure similar to that of the conventional passive PFC circuit, which is composed of a first reactance device, such as an inductor L1, a bridge rectifier B1 and a second reactance device, such as a capacitor C1.

Wherein, the positive AC output terminal of the AC voltage source V1 is coupled to the first terminal 321 of the inductor L1 through the route 341. The second terminal 323 of the inductor L1 is coupled to the first terminal 325 of the bridge rectifier B1 through the route 343. The second terminal 327 of the bridge rectifier B1 is coupled to the negative AC output terminal of the AC voltage source V1 through the route 345. In addition, the third terminal 329 of the bridge rectifier B1 is coupled to the first terminal 331 of the capacitor C1 through the route 347. The second terminal 333 of the capacitor C1 is coupled to the fourth terminal 335 of the bridge rectifier B1.

After the DC rectification circuit 301 receives the AC voltage supplied by the AC voltage source V1, a stable DC voltage processed and transformed by the DC rectification circuit 301 is output to charge the capacitor C1. The first load 305 is then driven. In this embodiment, the first load 305 is a resistor R2.

In the present invention, the PFC auxiliary circuit 304 is coupled between the input and output terminals of the DC rectification circuit 301. The PFC auxiliary circuit 304 comprises a resonant circuit 303 and a second DC rectification 306. The harmonic circuit 303 comprises the third reactance device 307 and the fourth reactance device 309. Wherein, the third reactance device 307 is the inductor L2, and the fourth device 309 is the capacitor C2 in this embodiment. The resonant circuit 303 provides a current path to improve the charging of the capacitor C1 of the DC rectification circuit during the continuous periodical variation of the positive and negative waveform of the AC signal. Of course, one of the ordinary skill in the art would know that the third reactance device can be a resistor, for example.

In this embodiment, in order to control the charging current path of the capacitor C1, the second DC rectification 306 is coupled between the capacitor C2 of the resonant circuit 303 and the capacitor C1 of the DC rectification circuit 301. The second DC rectification 306 comprises diodes D1 and D2. Wherein, the anode of the diode D1 is coupled to the capacitor C2 through the route 351; the cathode of the diode D1 is coupled to the capacitor C1 through the route 353. The anode of the diode D2 is coupled to the fourth terminal 335 of the bridge rectifier B1 through the route 355. The cathode of the diode D2 is coupled to the capacitor C2 through the route 357.

When the AC voltage output from the AC voltage source V1 is the positive half cycle, the PFC apparatus has two charging routes for the capacitor C1. Wherein, the first charging route is from the positive AC output terminal of the AC voltage source V1, through the inductor L1, the first terminal 325 of the bridge rectifier B1, the capacitor C1, the fourth terminal 335 of the bridge rectifier B1, and the second terminal 327 of the bridge rectifier B1, to the negative AC output terminal of the AC voltage source V1, to complete the first full charging route.

The second charging route is from the positive AC output terminal of the AC voltage source V1, through the inductor L2, the capacitor C2, the diode D1, the first capacitor C1, the fourth terminal 335 of the bridge rectifier B1, and the second terminal 327 of the bridge rectifier B1, to the negative AC output terminal of the AC voltage source V1, to complete the second full charging route.

When the AC voltage output from the AC voltage source V1 is the negative half cycle, the PFC apparatus also has two charging routes for the capacitor C1. Wherein, the first charging route is from the negative AC output terminal of the AC voltage source V1, through the second terminal 327 of the bridge rectifier B1, the third terminal 329 of the bridge rectifier B1, the capacitor C1, the fourth terminal 335 of the bridge rectifier B1, the first terminal 325 of the bridge rectifier B1, and the inductor L1, to the positive AC output terminal of the AC voltage source V1, to complete the first full charging route, while the AC voltage is the negative half cycle.

The second charging route, when the AC voltage is the negative half cycle, is from the negative AC output terminal of the AC voltage source V1, through the second terminal 327 of the bridge rectifier B1, the third terminal 329 of the bridge rectifier B1, the capacitor C1, the diode D2, the capacitor C2, and the inductor L2, to the positive AC output terminal of the AC voltage source V1, to complete the second full charging route, while the AC voltage is the negative cycle.

From the descriptions above, either the AC voltage of the AC voltage source V1 is the positive or negative half cycle, the capacitor C1 is charged through the first or second charging route. As a result, the conduction time of the input voltage can be effectively increased, and the working current peak of the input current IL1 can be restrained. The following is how the signals are processed by the circuit according to the signal waveform variations of the apparatus.

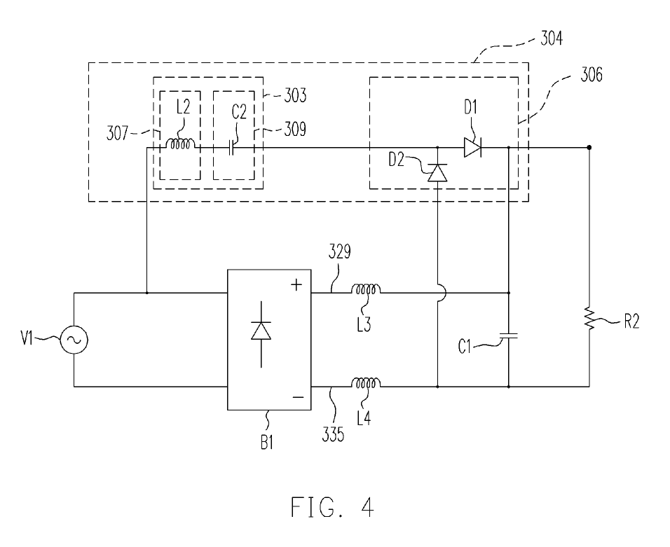

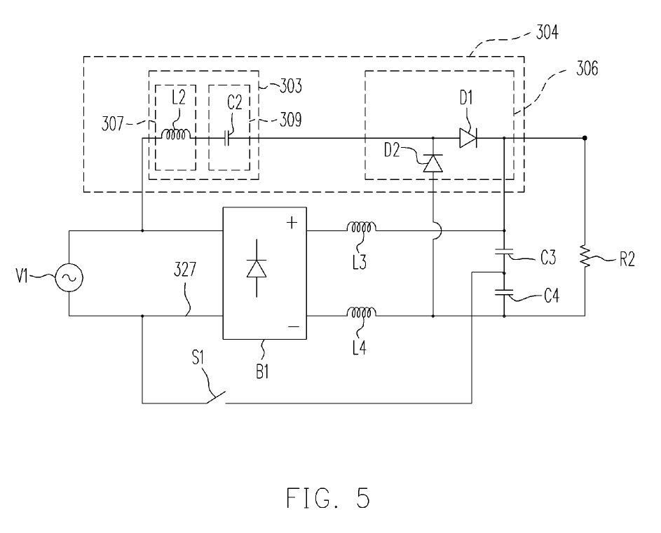

FIGS. 4 and 5 are schematic circuit drawings of PFC apparatuses according to other embodiments of the present invention. The significant difference between the circuits of FIGS. 3 and 4 is that the serially connected inductors L3 and L4 replace the inductor L1 coupled between the AC voltage source V1 and the bridge rectifier B1. Wherein, the inductors L3 and L4 can be a single couple choke. The inductor L3 is coupled between the third terminal 329 of the bridge rectifier B1 and the capacitor C1. The inductor L4 is coupled between the capacitor C1 and the fourth terminal 335 of the bridge rectifier B1. The signal processing in this embodiment is similar to that in FIG. 3.

In addition to the modifications of the circuit in FIG. 4, in the circuit of FIG. 5, the serially connected capacitors C3 and C4 replace the capacitor C1, and a switch S1 between the capacitors C3 and C4 is coupled to the second terminal 327 of the bridge rectifier B1 to control the circuit. The signal processing in this embodiment also is similar to that in FIG. 3. One of ordinary skill in the art would know that the inductors L3 and L4 can be replaced by a single coupled inductor.

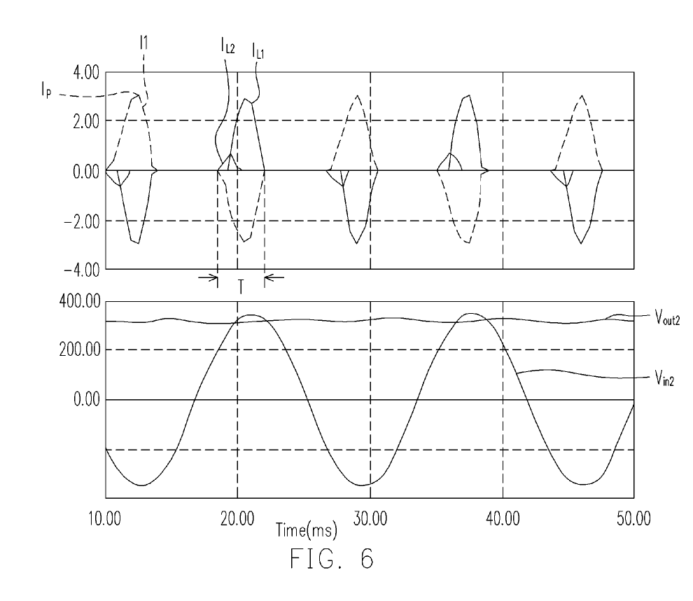

FIG. 6 is a drawing of a waveform of signal variations in a PFC apparatus according to an embodiment of the present invention. In the following, the waveform variations of FIG. 6 based on the PFC apparatus in FIG. 3 are discussed. Referring to FIG. 6, the AC voltage Vin2 is the AC voltage provided by the AC voltage source V1 shown in the bottom of this figure. After processed by the PFC apparatus of the present invention, the stable DC voltage Vout2 is output to drive the resistor R2.

In the top of FIG. 6, the current I1 in dotted line is the current provided by the AC voltage source V1. The current IL1 in solid line is the working current of the inductor L1; the current IL2 in solid line is the working current of the inductor L2. In order to describe the signal variations in detail, though having the same direction, the currents IL1 and I1 are shown with reverse current directions in this figure.

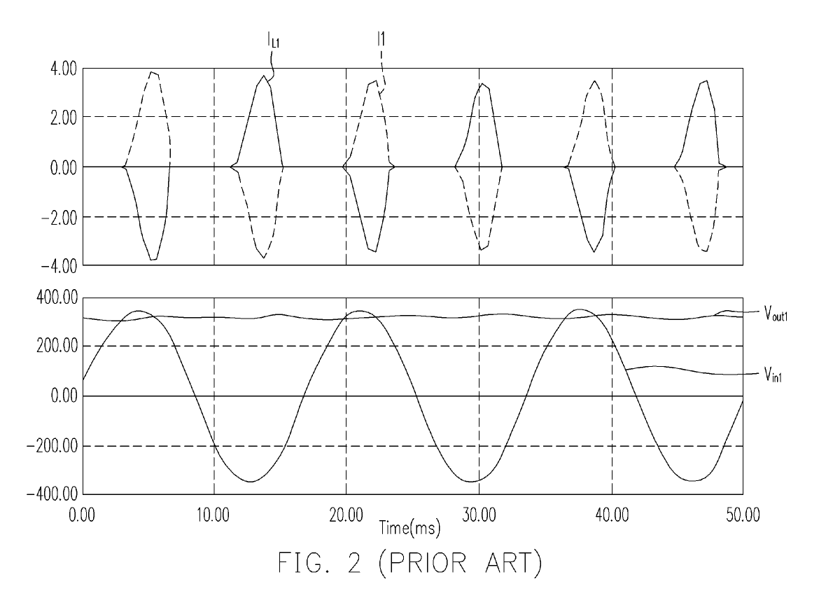

The signal waveform variations of FIG. 6 are compared with the waveform signal variations of the passive PFC circuit of FIG. 2. It is obvious that the conduction time T of the current I1 provided by the AC voltage source V1 is increased. This is because a charging route is provided in the resonant circuit 303 coupled in the PFC apparatus either the AC voltage of the capacitor C2 and the inductor L2 is the positive or negative half cycle.

Before the capacitor C1 is charged, the inductor L2 is turned on, and the conduction time I of the current I1 is increased, whereas the conduction time of the inductor L1 is not changed. With the additional charging route, the current flowing through the one charging route in the prior art is divided into two charging routes. Compared with the current peak shown in FIG. 2, the current peak IP shown in FIG. 6 is substantially reduced. The working current peak thus is restrained.

Accordingly, in the PFC apparatus of the present invention, a PFC auxiliary circuit is coupled between the input and output terminals of the DC rectification circuit to provide an additional current path so as to increase the conduction time of the charging current of the circuit and also restrain the input working current peak. Thus, the problems of increasing the size of the choke and the inductance of the inductor are prevented, while the circuit performance is improved.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A power factor correction (PFC) apparatus, connecting and receiving an alternating current (AC) voltage output from an AC source, the PFC apparatus comprising:
a DC rectification circuit, receiving the AC voltage and outputting a direct current (DC) voltage based on the AC voltage;
a load, a first terminal of the load being coupled to a first output terminal of the DC rectification circuit, a second terminal of the load being coupled to a second output terminal of the DC rectification circuit; and
a PFC auxiliary circuit, an input terminal of the PFC auxiliary circuit being electrically coupled to a positive AC input terminal of the AC source, while an output terminal of the PFC auxiliary circuit being electrically coupled to the first terminal of the load to provide part of a working current of the load.

2. The PFC apparatus of claim 1, wherein the DC rectification circuit comprises:
a first reactance device, a first terminal of the first inductive reactance being coupled to the positive AC input terminal of the AC source;
a bridge rectifier, a first terminal of the bridge rectifier being coupled to a second terminal of the first reactance device, a second terminal of the bridge rectifier being coupled to a negative AC input terminal of the AC source; and
a second reactance device, a first terminal of the second reactance device being coupled to a third terminal of the bridge rectifier, a second terminal of the second reactance device being coupled to a fourth terminal of the bridge rectifier.

3. The PFC apparatus of claim 2, wherein the first terminal of the load is electrically coupled to the first terminal of the second reactance device, and the second terminal of the load is electrically coupled to the second terminal of the second reactance device.

4. The PFC apparatus of claim 2, wherein the first reactance device is an inductor.

5. The PFC apparatus of claim 2, wherein the second reactance device is a capacitor.

6. The PFC apparatus of claim 2, wherein the third terminal of the bridge rectifier is a positive DC output terminal, and the fourth terminal of the bridge rectifier is a negative DC output terminal.

7. The PFC apparatus of claim 1, wherein the DC rectification circuit comprises:
a bridge rectifier, a first terminal of the bridge rectifier being coupled to the positive AC input terminal of the AC source, a second terminal of the bridge rectifier being coupled to a negative AC input terminal of the AC source;
a first reactance device, a first terminal of the first reactance device being coupled to a third terminal of the bridge rectifier;
a second reactance device, a first terminal of the second reactance being coupled to a second terminal of the first reactance; and
a third reactance device, a first terminal of the third reactance being coupled to a second terminal of the second reactance, a second terminal of the third inductive reactance device being coupled to a fourth terminal of the bridge rectifier.

8. The PFC apparatus of claim 7, wherein the first reactance device is an inductor.

9. The PFC apparatus of claim 7, wherein the second reactance device is a capacitor.

10. The PFC apparatus of claim 7, wherein the third reactance device is an inductor.

11. The PFC apparatus of claim 1, wherein the DC rectification circuit comprises:
a bridge rectifier, a first terminal of the bridge rectifier being coupled to the positive AC input terminal of the AC source, a second terminal of the bridge rectifier being coupled to a negative AC input terminal of the AC source;
a first reactance device, a first terminal of the first reactance device being coupled to a third terminal of the bridge rectifier;
a second reactance device, a first terminal of the second reactance being coupled to a second terminal of the first reactance;
a third reactance device, a first terminal of the third reactance being coupled to a second terminal of the second reactance;
a fourth reactance device, a first terminal of the fourth reactance device being coupled to a second terminal of the third reactance, the second terminal of the fourth reactance device being coupled to a fourth terminal of the bridge rectifier; and
a switch, a first terminal of the switch being coupled to the second terminal of the second inductive reactance device, a second terminal of the switch being coupled to the negative AC input terminal of the AC source.

12. The PFC apparatus of claim 11, wherein the first reactance device is an inductor.

13. The PFC apparatus of claim 11, wherein the second reactance device is a capacitor.

14. The PFC apparatus of claim 11, wherein the third reactance device is a capacitor.

15. The PFC apparatus of claim 11, wherein the fourth reactance device is an inductor.

16. The PFC apparatus of claim 11, wherein the first and fourth inductive reactance devices comprise a couple choke.

17. The PFC apparatus of claim 1, wherein the PFC auxiliary circuit comprises a resonant circuit, the resonant circuit comprising:
a third reactance device, a first terminal of the third reactance device being coupled to the positive AC input terminal; and
a fourth reactance device, a first terminal of the fourth reactance device being coupled to a second terminal of the third reactance device, a second terminal of the fourth inductive reactance device being coupled to the input terminal of the DC rectification circuit.

18. The PFC apparatus of claim 17, wherein the PFC auxiliary circuit further comprises a second DC rectification, an input terminal of the second DC rectification being coupled to the second terminal of the fourth reactance, and a first output terminal of the second DC rectification circuit being coupled to the first output terminal of the DC rectification circuit, and a second output terminal of the second DC rectification circuit being coupled to the second output terminal of the DC rectification circuit.

19. The PFC apparatus of claim 18, wherein the second DC rectification circuit is a first diode.

20. The PFC apparatus of claim 19, wherein a first terminal of the first diode is an anode, and a second terminal of the first diode is a cathode.

21. The PFC apparatus of claim 18, wherein the second DC rectification circuit further comprises a second diode, a first terminal of the second diode is coupled to the first terminal of the first diode, and a second terminal of the second diode is coupled to the second output terminal of the DC rectification circuit.

22. The PFC apparatus of claim 21, wherein a first terminal of the second diode is a cathode, and a second terminal of the second diode is an anode.

23. The PFC apparatus of claim 17, wherein the third reactance device is an inductor.

24. The PFC apparatus of claim 17, wherein the fourth reactance device is a capacitor.

25. The PFC apparatus of claim 17, wherein the third reactance device is a resistor.

26. The PFC apparatus of claim 1, wherein the load is a resistor.

27. The PFC apparatus of claim 1, wherein the load is an electronic devices.
